(19) United States
(12) Patent Application Publication
(10) Pub. No.: US 2008/0030859 A1
(43) Pub. Date: Feb. 7, 2008

(54) DAYLIGHTING FILM, METHOD FOR PRODUCING THE SAME AND WINDOW EQUIPPED THEREWITH

(75) Inventor: Yoshihisa USAMI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/765,171

(22) Filed: Jun. 19, 2007

(30) Foreign Application Priority Data
Aug. 3, 2006 (JP) 2006-212580

(51) Int. Cl. F21S 11/00; B29D 11/00

(52) U.S. Cl. 359/592; 264/1.9

(57) ABSTRACT

The present invention is to provide a daylighting film that can provide incident sunlight from a window to desired indoor spots such as ceilings, increase indoor illumination, allows for easy installation, easy cleaning, and ensuring efficiency of taking sunlight into the indoors, a method for producing the daylighting film and a window equipped with the daylighting film. That is, the method includes forming unit prisms 3 each having two or more surfaces, on at least one surface of a translucent support 2, forming one or more reflecting layers 4 on one or more surfaces of each of the unit prisms 3, and forming a protection layer 5 having a flat surface 5a to cover the unit prisms 3.

### BACKGROUND OF THE INVENTION

1. Field of the Invention

The present invention relates to a daylighting film, a production method thereof and a window equipped therewith.

2. Description of the Related Art

Japanese Utility Model Application Laid-Open (JP-U) No. 7-39008, Japanese Patent Application Laid-Open (JP-A) Nos. 2001-305473 and 2000-28956 propose methods to efficiently take incident sunlight from windows into the indoors.

Those disclosed three methods, however, require large-scale installations because the methods aim at taking a great amount of sunlight into the indoors. For that reason, methods to efficiently take sunlight using louvers or slats (window shades) are proposed in JP-A Nos. 2004-278068, 2000-170467, 11-36739, 2004-363042, 10-317850 and 11-315673.

Those six disclosed methods are effective in taking direct sunlight. However, because they use window shades, and the window shades are originally used to shut out incident sunlight, the window shades used in the methods cannot take sunlight other than direct sunlight, resulting in a reduction in their efficiency.

Moreover, areas, through which sunlight cannot go, of windows look dark when looked from the indoors, resulting in a reduction in comfortableness with the use of the windows. Furthermore, the indoors becomes remarkably dark under a cloudy sky.

Thus, JP-A Nos. 8-313795 and 11-280350 respectively propose locating prisms on windows as a method to take both direct and indirect sunlight to brightly lighten the indoors even under a cloudy sky.

However, prisms used in the method of JP-A No. 8-313795 are excessively large to be placed on commonly used windows located in houses, and thus the method lacks usability. The technique disclosed in JP-A No. 11-280350 has a configuration in which a resin sheet with prisms formed on a surface thereof is only affixed to a window, and thus the technique lacks inventiveness in efficiently providing sunlight to the indoors and, in particular, to ceilings.

Additionally, the usability of the methods proposed in the above-mentioned JP-A Nos. 8-313795 and 11-280350 is remarkably poor to be placed on windows for common houses, because, first, they require a great effort at installation, and secondly, the outer surface of prisms formed for refracting incident light covers the entire surface of a support, which would cause problems that dust will easily accumulate in gaps between the prisms and that dust cannot easily be removed, and thus a reduction in the efficiency in taking sunlight cannot be prevented.

Therefore, as both a daylighting film that can provide incident sunlight from a window to desired indoor spots such as ceilings, increase indoor illumination, allows for easy installation, easy cleaning, and ensuring efficiency of taking sunlight into the indoors, and a window equipped with the daylighting film have not yet been provided so far.

### BRIEF SUMMARY OF THE INVENTION

The object of the present invention is to solve aforementioned problems and to achieve the following objects. That is, the present invention is to provide a daylighting film that can provide incident sunlight from a window to desired indoor spots, increase indoor illumination, allows for easy installation, easy cleaning and ensuring efficiency of taking sunlight into the indoors, and a window equipped with the daylighting film.

The means to solve aforementioned problems are as follows.

The method for producing a daylighting film of the present invention includes forming unit prisms each having two or more surfaces, on at least one surface of a translucent support, forming one or more reflecting layers on one or more surfaces of each of the unit prisms, and forming a protection layer having a flat surface to cover the unit prisms.

The daylighting film of the present invention is characterized in that the daylighting film is produced by a method for producing a daylighting film. The method includes forming unit prisms each having two or more surfaces, on at least one surface of a translucent support, forming one or more reflecting layers on one or more surfaces of each of the unit prisms, and forming a protection layer having a flat surface to cover the unit prisms.

The window of the present invention is characterized in that the window is equipped with a daylighting film which is produced by the method for producing a daylighting film. The method includes forming unit prisms each having two or more surfaces, on at least one surface of a translucent support, forming one or more reflecting layers on one or more surfaces of each of the unit prisms, and forming a protection layer having a flat surface to cover the unit prisms.

### BRIEF DESCRIPTION OF THE SEVERAL VIEWS OF THE DRAWINGS

FIG. 1 is a perspective illustration exemplarily showing a configuration of the daylighting film of the present invention.

FIG. 2 is a perspective illustration exemplarily showing a form of unit prisms in another embodiment of the daylighting film of the present invention.

FIG. 3 is a schematic illustration exemplarily showing an embodiment of the window equipped with the daylighting film of the present invention.

FIG. 4 is a schematic illustration exemplarily showing a light path of incident light shined in through a window and emitted light therefrom equipped with the daylighting film of the present invention.

FIG. 5 shows a configuration of a production apparatus for producing unit prisms, the apparatus used in a method for producing a daylighting film of the present invention.

FIG. 6 is a cross-sectional view showing a configuration of a deposition apparatus used for forming a reflecting layer in the method for producing a daylighting film of the present invention.

FIG. 7 is a cross-sectional view exemplarily showing an arrangement of a support and an evaporation source in the deposition apparatus at a reflecting layer forming step in the method for producing a daylighting film of the present invention.

FIG. 8 is a sectional view showing a configuration of the daylighting film of Example 2 in the present invention.

FIG. 9 is a sectional view showing a configuration of the daylighting film of Example 3 in the present invention.

FIG. 10 is a sectional view showing a configuration of the daylighting film of Example 4 in the present invention.

FIG. 11 is a sectional view showing a configuration of the daylighting film of Example 5 in the present invention.

### DETAILED DESCRIPTION OF THE INVENTION

(Daylighting Film)

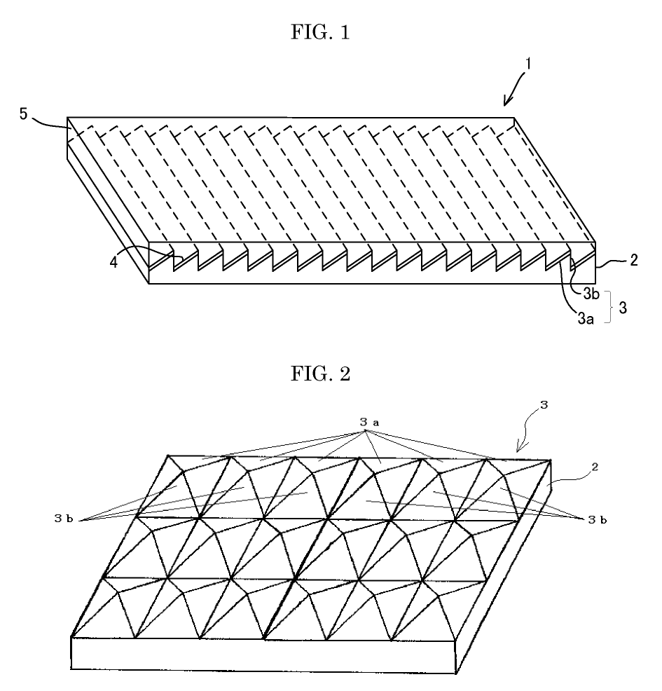

FIG. 1 is a perspective illustration showing a configuration of the daylighting film of the present invention.

As shown in FIG. 1, the daylighting film 1 of the present invention is composed of a support 2, unit prisms 3 which are formed on at least one surface of the support 2 for concentrating incident light, passing through the film in a direction from the prisms to the support, into a specific area, and a protection layer 5 covering a substantially entire surface of the unit prisms 3. Prism sheets and lenticular lenses are commonly used for such daylighting film 1. Besides those mentioned above, diffraction gratings and the like are also exemplified.

Each of the unit prisms 3 has at least two surfaces, and one or more reflecting layers 4 are formed on at least one surface of each of the unit prisms.

Additionally, the daylighting film 1 of the present invention may contain a light diffusion layer, a back layer, an intermediate layer and other layers in accordance with necessity.

<Support>

The shape of the support 2 is not particularly limited and may be suitably selected in accordance with the intended use. Examples of the shape include rectangles, squares, and round shapes.

The structure of the support 2 is not particularly limited and may be suitably selected in accordance with the intended use. A single-layer and a multi-layered structure are exemplified.

The size of the support 2 is not particularly limited and may be suitably selected in accordance with the intended use.

The average thickness (T) of the support 2 is not particularly limited and can be a suitable thickness in accordance with the intended use, provided that it is within the range of thickness typically used for a support 2. The average thickness is preferably in the range of 10 μm to 10 mm, more preferably 50 μm to 5 mm, and further preferably 100 μm to 1 mm.

The average thickness of the support 2 can be measured with, for example, a thickness meter that measures a thickness of a film by sandwiching the film in between measurement sensors, or a non-contact thickness meter that measures thickness using optical interference.

Material of the support 2 is not particularly limited, provided it is translucent and has sufficient strength. Examples of the material include resins and glasses. Of those materials, resins are preferable because of their high plasticity and light weight.

The resin is not particularly limited, and, in accordance with necessity, can be selected from, for example, thermoplastic resins and thermosetting resins.

Examples of the thermoplastic resins include polymethyl methacrylate resins (PMMA), polycarbonate resins, polystyrene resins, MS resins, AS resins, polypropylene resins, polyethylene resins, polyethylene terephthalate resins, polyvinyl chloride resins (PVC), thermoplastic elastomers or copolymers thereof and cycloolefin polymers. Those resins can be used alone or in combination.

The haze of the support 2 is preferably 50% or less, more preferably 30% or less, and further preferably 10% or less. When that haze is more than 50%, efficiency in taking and controlling incident light, or light concentration efficiency, may be significantly degraded.

As used hereinafter, the term “haze” means that percentage of transmitted light which in passing through the specimen deviates from the incident beam by forward scattering, and values thereof can be measured with measurement devices such as HZ-1 (a haze meter, manufactured by Suga Test Instruments) conforming to JIS 7105 standard.

<Unit Prism>

The daylighting film of the present invention is configured by forming prisms on the support 2, so that it can more efficiently concentrate light into a specific spot than a support on which only one prism is formed. And each of the prisms is called a unit prism 3 in the present invention.

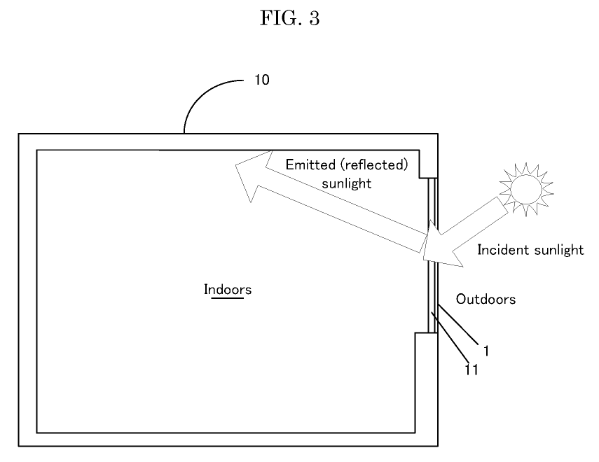

The shape of the unit prism 3 formed on the support 2 is not particularly limited, and can be selected from shapes in accordance with the intended use, provided that the shape is suitable for efficiently concentrating incident light, passing from the support 2, into a specific spot such as ceilings. Examples of shapes that can be used include a plurality of triangular unit prisms (hereinafter, each of the triangular unit prisms may be called a prism column), each having a ridge line arranged parallel to each other at predetermined intervals in a direction perpendicular to the direction of the ridge line, formed on the support 2 as shown in FIG. 1; and quadrangular pyramid shaped-unit prisms arranged in a lattice arrangement as shown in FIG. 2.

Of those shapes, the prism column is preferable because it can efficiently be produced.

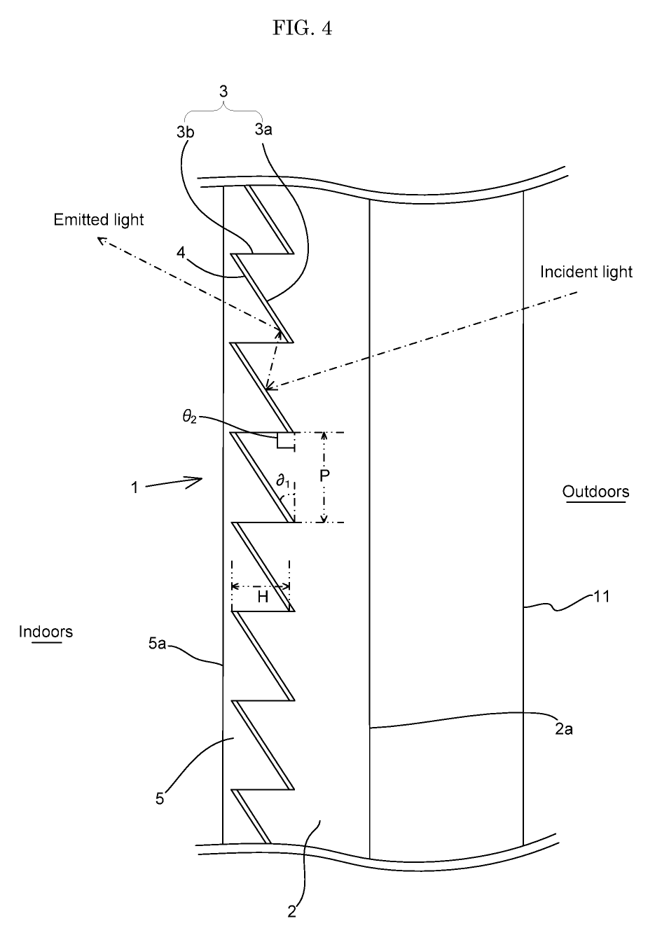

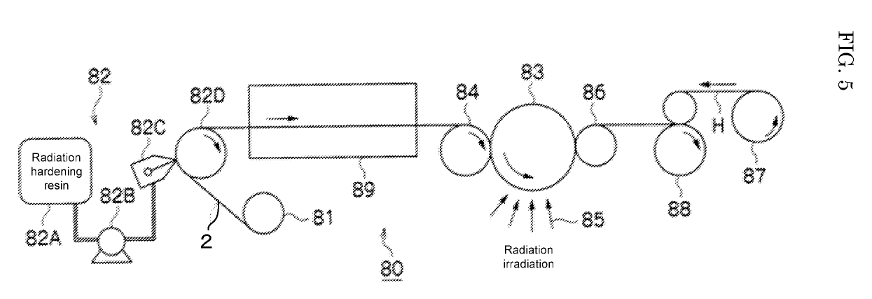

FIG. 4 shows a light path of incident sunlight passing through a window 11 located in the indoors 10. The window is equipped with the daylighting film 1 of the present invention, on which the unit prisms 3 are formed and arranged parallel with each other. As shown in FIG. 4, sunlight passing through the window 11 passes through the support 2, reflects at a reflecting layer 4 which is formed on a first surface 3a of the unit prism 3, passes through a second surface 3b of another unit prism 3 and reflects at a reflecting layer 4 formed on a first surface 3a of that another unit prism 3. That sunlight is thereby emitted to an indoor ceiling.

In respect of the size of the unit prisms 3, the pitch P, or the interval between two unit prisms 3, is preferably in the range of 1 μm to 10 mm, more preferably 5 μm to 5 mm, and further preferably 10 μm to 1 mm. The pitch P is the interval between two unit prisms 3. The unit prisms preferably have a height of 10 μm to 10 mm measured from the surface of the support 2. The height is more preferably in the range of 50 μm to 5 mm, and further preferably 100 μm to 1 mm measured from the support 2. The elevation angle θ₁, an angle to the support 2, of the unit prisms 3 is preferably in the range of 5° to 75°, more preferably 10° to 60°, and further preferably 20° to 45°, and is particularly preferably 30°.

Additionally, the elevation angle θ₁ and θ₂ of the unit prisms 3 to the support 2 may vary in each unit prism depending on where each prism is placed. For example, in a daylighting film 1 composed of a support 2 on which unit prisms 3 are formed in column arrangement, elevation angles of unit prisms formed at a lower position of the film may be larger or smaller than that of unit prisms formed at an upper position in order to narrow the angle of light refracted at the indoor surface of the window so that light emitted will be more concentrated at the ceiling.

<<Reflecting Layer>>

As mentioned above, each of the unit prisms 3 has at least two surfaces, and a reflecting layer 4 is formed on at least one surface of the surfaces. When each of the unit prisms 3 has two surfaces and a ridge line in a direction and is arranged such that the respective ridge lines are parallel to each other at predetermined intervals in a direction perpendicular to the direction of the ridge lines, the reflecting layer 4 is formed on one of the two surfaces of the unit prisms 3.

And when each of the unit prisms 3 has four surfaces and is a quadrangular pyramid shaped-unit prism arranged in a lattice arrangement as shown in FIG. 2, reflecting layers 4 may be formed on up to three surfaces of the unit prisms 3.

In either case, each of the reflecting layers 4 is preferably formed on common surfaces of the respective unit prisms 3. When each of the unit prisms 3 has two surfaces, the reflecting layers 4 are preferably formed on a surface of each of the unit prisms so that the reflecting layers 4 are formed in a louver arrangement in cross sectional view.

For efficiently reflecting incident light, the reflecting layers 4 are preferably made with a material having a high luster. Of such materials, metal and the like are commonly used. Methods such as vacuum deposition are preferably used for forming the reflecting layers 4 on the surfaces of the unit prisms 3. In vacuum deposition methods, aluminum is preferably used as it can easily be treated.

<Protection Layer>

The daylighting film 1 of the present invention has the unit prisms 3, the reflecting layers 4 which cover one or more surfaces of each of the unit prisms 3, and the protection layer 5 formed to cover the unit prisms 3. The protection layer 5 has a flat surface 5a which is formed to cover the unit prisms 3 and is the surface of the protection layer 5 opposite to the surface facing the unit prisms 3. When unit prisms 3 are formed on only one surface of the support 2, the flat surface 5a is formed parallel with the surface 2a which is the surface of the support 2 opposite to the surface on which unit prisms 3 are formed.

(Window Equipped with Daylighting Film)

As shown in FIG. 3, a window 11 which is located in the indoors 10 and equipped with the daylighting film of the present invention serves as a window which can efficiently take incident sunlight into the indoors and illuminate the indoors by concentrating that sunlight at a specific spot (such as ceilings).

A method and place to affix the daylighting film 1 to the window 11 are not particularly limited, and they can be selected from suitable methods and places in accordance with purpose as long as effects induced by the unit prisms 3 are not impaired. It is preferable to affix the daylighting film to the window 11 such that the support 2 makes contact with the indoor surface of the window 11 using a translucent adhesive or the like. The daylighting film 11 is preferably placed inside a room. In this case, the film can be prevented from deterioration that is caused by the outside environment.

Light Diffusion Layer

In the present invention, a light diffusion layer (not shown in figures) may be formed on the support 2 in accordance with necessity. The light diffusion layer can be formed by applying a coating solution which is composed of a resin, a volatile liquid and particles onto a surface of the support 2 and drying that applied coating solution.

The components of the coating solution include a resin, a volatile liquid and particles. And it may contain other components in accordance with necessity.

The resin is not particularly limited, and can be selected from suitable resins according to purpose. Examples thereof include acrylate resins and styrene-butadiene resins.

Examples of the volatile liquid include methylethylketones (MEK), cyclohexanones, toluenes and water.

The shape of the particles may be spherical, elliptical sphere or comma-shaped.

The average particle diameter of the particles is preferably larger than the average thickness of the dried coated layer, that is, it is preferably in the range of 0.5 μm to 50 μm.

The average particle diameter can be measured with a measurement device using, for example, a dynamic light scattering or a laser diffraction method.

The particles are not particularly limited, and can be selected from suitable particles. Examples of the particles include organic particles and inorganic particles.

The organic particles are not particularly limited, and can be selected from suitable particles. Examples of the particles include polymethyl methacrylate resin particles, melamine resin particles, polystyrene resin particles and silicone resin particles. These particles may be used alone or in combination.

The organic particles preferably have a cross-linked structure.

Preferred examples of the organic particles having a cross-linked structure include acrylate resin particles that have a cross-linked structure.

The inorganic particles are not particularly limited, and can be selected from suitable particles. Examples of the particles include particles of talcs, calcium carbonates, silicones and aluminas. These particles may be used alone or in combination.

The added amount of the particles is preferably in the range of 1 part by mass to 1,000 parts by mass, and more preferably 25 parts by mass to 400 parts by mass relative to 100 parts by mass of the resin. When the added amount of the particles is less than 1 part by mass, the particles may not serve as a light diffusing agent, and when more than 1,000 parts by mass, particles may not be sufficiently dispersed.

The ratio of the refractive index of the resin to the refractive index of the particles is not particularly limited, and can be adjusted at a suitable level according to purpose. For example, the ratio of refractive indexes of a D line having a wavelength of 589 nm, measured at 25° C., is preferably in the range of 0.9 to 1.1, and more preferably 0.95 to 1.05.

When the ratio of the refractive index of the resin to the refractive index of the particles is less than 0.9 or more than 1.1, the amount of reflected light component may be large at boundary surfaces of the particles and resin, resulting in a reduction of the transmittance of light.

The other components are not particularly limited, and can be selected from suitable components according to purpose. Examples thereof include particle-anti-settling additives, fluorochemical surfactants, diffusing agents, thickeners, cationic surfactants, anionic surfactants, curing agents, cross linking agents, photopolymerization initiators and monomers.

Examples of the particle-anti-settling additives include fatty amides, polyethylene oxides, metallic soaps, organic bentonites and hydrogenated castor oil waxes. Of those anti-settling additives, fatty amides and polyethylene oxides are preferable. These components can be used alone or in combination.

Since the diffusing agents serves as light diffusing agents similarly to the above-mentioned particles, they can further improve light diffusion property.

The average particle diameter of the diffusing agent is not particularly limited, and can be adjusted at a suitable diameter according to purpose. For example, it is preferably in the range of 1 μm to 5 μm.

The average particle diameter of the diffusing agent is not particularly limited, and can be measured with measurement devices using, for example, a dynamic light scattering or a laser diffraction method.

Materials of the diffusing agents are not particularly limited, and can be selected from, for example, silicas, calcium carbonates, aluminas and zirconias.

The added amount of the diffusing agent in the coating solution is not particularly limited, and can be adjusted at a suitable level according to purpose. For example, it is preferably in the range of 1 part by mass to 20 parts by mass relative to the total amount of the coating solution.

The thickeners are not particularly limited, and can be selected from suitable ones. Examples thereof include copolymers between an acrylamide and an amine salt.

The added amount of the thickener is preferably in the range of 0.1 parts by mass to 10 parts by mass relative to 100 parts by mass of the resin.

The fluorochemical surfactants are not particularly limited, and can be selected from suitable surfactants. Examples thereof include anionic fluorochemical surfactants and amphoteric fluorochemical surfactants.

The added amount of the fluorochemical surfactant is preferably in the range of 0.001 parts by mass to 0.1 parts by mass relative to 100 parts by mass of the resin.

The surface tension of the coating solution is preferably 40N/m or less, and more preferably 30N/m or less. When the surface tension is more than 40N/m, the surface condition of the coated layer may be degraded.

The surface tension of the coating solution can be measured with, for example, CBVP-A3 (an automatic surface tension meter, manufactured by Kyowa Interface Science Co., Ltd.).

The viscosity of the coating solution is not particularly limited, and can be adjusted at a suitable level according to purpose. For example, it is preferably in the range of 10 mPa·s to 200 mPa·s, and more preferably 5 mPa·s to 150 mPa·s at 25° C. When the viscosity is less than 10 mPa·s, it may be difficult to maintain particle-sedimentation at a satisfactory level, and when more than 200 mPa·s, the flowability, paintability and surface condition of the coating solution may be degraded.

The viscosity of the coating solution can be measured with, for example, a type-E viscometer (an ELD type viscometer, manufactured by Tokyo Keiki Co., Ltd.).

The concentration of solid content in the coating solution is not particularly limited, and can be adjusted at a suitable level according to purpose. It is preferably in the range of 10 parts by mass to 40 parts by mass, and more preferably 20 parts by mass to 30 parts by mass relative to 100 parts by mass of the coating solution.

(Method for Producing Daylighting Film)

<Unit Prism Forming Step>

A method of forming unit prisms 3 on the support 2 in manufacturing the daylighting film 1 is not particularly limited, and may be selected from suitable methods according to purpose. Examples of the forming method include (1) forming prisms by feeding a resin sheet extruded from a die in between an embossing (transfer) roller that has a reversed pattern of the unit prisms 3 on the surface thereof and a nip roller to tightly press the resin sheet in between the embossing (transfer) roller and the nip roller to thereby transfer the pattern i.e. the shape of the unit prisms 3 to the surface of the resin sheet. The embossing (transfer) roller rotates at almost same speed as the extrusion speed of the resin sheet. And the nip roller is placed facing the embossing roller. Additionally, for the forming method, (2) another method is also exemplified in which a transfer mold or a stamper having a reversed pattern of the unit prism 3 on the surface thereof is placed on a resin plate in a laminate structure, and the resin plate is pressed using a hot press to thermally transfer the reversed pattern to transfer the shape of the unit prisms 3 on the resin plate surface, thereby producing a daylighting film 1 with the unit prisms 3 formed thereon.

The examples further include (3) forming unit prisms 3 on a translucent film made with, polyesters, acylated celluloses, acryls, polycarbonates, polyolefins or the like using a pattern roller having reversed patterns of the unit prism 3 on its surface to trnasfer the reversed patterns to the film.

More specifically, a sheet having unit prisms thereon may be produced by feeding a translucent film, the film on which an adhesive and resin are applied separately to form one or more adhesive layers and resin layers (such as a ultraviolet hardening resin layer), to the pattern roller to transfer the patterns, formed on the surface of the roller, to the resin layer(s), and hardening the resin layer(s) when the film is still in a contact state with the roller. The resin layer(s) can be harden by, for example, exposing to a ultraviolet radiation. Additionally, the adhesive may or may not be used.

Another example is that (4) forming a support having unit prisms thereon by pouring resin having the above-mentioned components into a metal mold with patterns of the unit prisms 3. In such case, the support 2 and unit prisms 3 are formed into a single-piece product, rather than forming the unit prisms 3 on the support 2 using, for example, an embossing roller.

FIG. 5 shows an example of a production apparatus for forming the unit prisms. As shown in the figure, the apparatus 80 for forming the unit prisms 3 includes a coating unit 82, drying unit 89, an embossing roller 83 and a resin hardening unit 85.

For example, a translucent PET (polyethylene terephthalate) film which is 500 mm wide and 100 μm thick may be used as a support 2.

A roller which is 700 mm long (in the width direction of the support 2) and 300 mm in diameter made with S45C, a carbon steel, and covered with nickel may be used as an embossing roller 83.

For example, for making an embossing roller of the above-mentioned roller, grooves will be formed with a 50 μm pitch in the axis direction on the entire circumference of the roller. The circumference may be about 500 mm long, and the grooves can be formed in a cutting process using a diamond cutting tool (with single point).

The cross sectional shape of the grooves is a rectangular triangle with an apex angle of 60°. That is, each of the grooves is 50 μm in width and 25 μm in depth.

The grooves are endless in the circumferential direction of the embossing roller 83. Using the roller, unit prisms 3 each having a triangle cross sectional shape can be formed on the support 2. The circumferential surface of the roller may be plated with nickel after the grooves are formed in the cutting process.

A die coater using an extrusion type coating head 82C is preferably used as a drying unit 82.

To form an organic solvent layer with a desired thickness after dried, the thickness of the coating solution (resin liquid) before dried will be controlled by adjusting the amount of each coating solution (resin liquid) supplied to the coating head 82C by a supply device 82B.

A circulating hot air dryer is preferably used as a drying unit 89. The temperature of hot air in the dryer is not particularly limited, and can be set at a suitable temperature according to purpose. It may be set at, for example, 100° C.

Likewise, the diameter and surface condition of the nip roller 84 and nip pressure (effective pressure), applied to the support 2 from the embossing roller 83 and nip roller 84, are not particularly limited and can be a suitable value/condition according to purpose.

A metal halide lamp may be preferably used as the resin hardening unit 85.

<Reflecting Layer Forming Step>

After the unit prisms have been formed, a reflecting layer 4 will be formed on one or more surface of each of the unit prisms 3 in the reflecting layer forming step. The method for forming the reflecting layers 4 can properly be selected from, for example, vacuum deposition with a vacuum deposition chamber, ion plating and sputtering methods. Of those methods, vacuum deposition and ion plating methods are preferable as, using the methods, reflecting layers can easily be formed only on the “one or more surfaces” to be formed with the reflecting layers.

The reflecting layers 4 are preferably formed on the one or more surfaces of the unit prisms so that the reflecting layers 4 are formed in a louver arrangement in cross sectional view of the daylighting film 1. For example, when the unit prisms 3 are arranged parallel with each other, reflecting layers 4 are formed on the first surfaces, 3a, facing the same direction, of the unit prisms 3. In this case, reflecting layers 4 are formed on the first surfaces 3a of the triangular unit prisms 3, and thus the reflecting layers 4 are arranged in a louver arrangement in cross sectional view.

A plasma or primer treatment is preferably conducted on a surface which is to be covered with a reflecting layer as a pretreatment for improving adhesive properties of deposition.

Vacuum Deposition Chamber

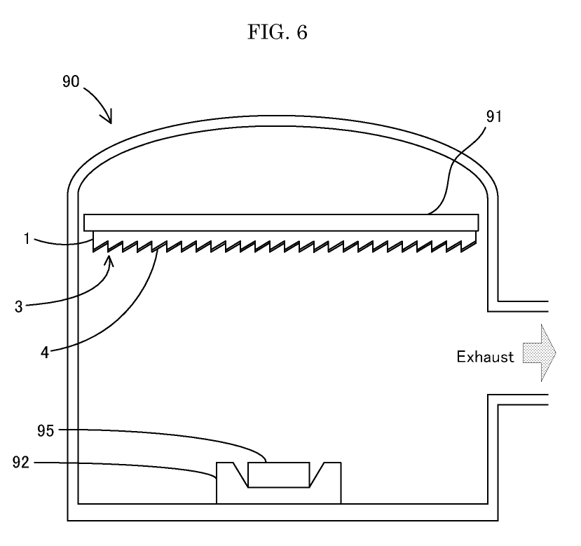

The reflecting layers 4 formed on the daylighting film of the present invention can be formed using a common vacuum deposition chamber such as one shown in FIG. 6.

That vacuum deposition chamber 90 includes a target holder 91 for supporting the support 2 which is a target of vacuum deposition, an evaporation material 95, a crucible 92 for heating and evaporating the evaporation material 95, and an exhaust system 93 for making the inside of the vacuum deposition chamber vacuum. The exhaust system 93 may be, for example, an oil diffusion pump, a rotary pump or a turbo molecular pump or a combination of two or more these pumps. Of those pumps, the turbo molecular pump is preferably used because of its facile vacuum operation. Additionally, shutters and a film thickness monitor are preferably installed in the vacuum deposition chamber in order to control the film thickness (or layer thickness) of the reflecting layer 4.

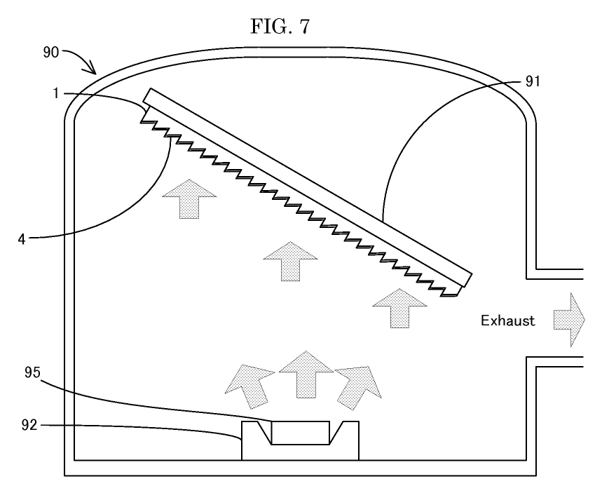

As shown in FIG. 7, the support 2 is positioned and selected surfaces (or the first surfaces 3a of the above mentioned “one or more surfaces”) of the unit prisms to be deposited are placed facing and perpendicular to the evaporation material 95 so that layers are formed only on the selected surfaces. For example, when the first surfaces 3a to be deposited are shadowed, the support 2 should be positioned at an angle at which the surfaces are not shadowed.

<Protection Layer Forming Step>

After forming the reflecting layers, the protection layer 5 which covers the unit prisms 3 and has the flat surface 5a is formed in the method for producing a daylighting film of the present invention.

The protection layer 5 in the present invention is preferably formed from an ultraviolet curable resin, a thermoseting resin or a two-component curable resin or formed by coating the unit prisms with solvent. Of these materials, the ultraviolet curable resin is more preferably used for forming the protection layers.

The viscosity of such resin before hardening is preferably in the range of 10 cps to 2,000 cps. When the viscosity is more than 2,000 cps, the flatness of the surface 5a will be degraded, and when less than 10 cps, sufficient thickness of the protection layer will not be obtained.

Difference in refractive indexes between the protection layer 5 and support 2 is preferably 0.2 or less, more preferably 0.1 or less and further preferably 0.05 or less, and most preferably the refractive indexes are substantially same. When the difference in refractive indexes is more than 0.2, diffused reflection will occur at the boundary surface, resulting in a decrease in efficiency of concentrating incident light into a given indoor spot such as ceilings.

Thus, a daylighting film 1, in which unit prisms 3 are formed on at least one surface of a support 2, reflecting layers 4 are formed on one or more surfaces of the unit prisms 3 and a protection layer 5 is formed on the support 2 so as to cover the unit prisms 3, can be obtained.

<Laminating Step>

In the present invention, a laminating step may be performed after the protection layer forming step. The laminating step is for bonding two daylighting films 1 so that reflecting layers 4 formed on unit prisms 3 are configured into bilayered louvers. The two daylighting films 1 can be layered by bonding surfaces 2a (or surfaces on which unit prisms 3 are not formed) of two supports 2 of the films when unit prisms 3 are formed on only one surface of the supports or by laminating daylighting films 1 directed at the same direction, the films having unit prisms 3 formed on only one surface of supports 2 and a protection layer 5 covering the unit prisms.

According to the present invention, a daylighting film that can solve conventional problems and provide incident sunlight from a window for desired indoor spots such as ceilings, help indoor illumination, easily be placed and cleaned, and maintain efficiency of taking sunlight into the indoors, and a window equipped with the daylighting film.

### EXAMPLES

Hereafter, the present invention will be further described in detail referring to specific Examples and Comparative Examples, however, the present invention is not limited to the disclosed Examples.

### Example 1

<Production of Daylighting Film>

<<Preparation of Resin Liquid>>

The following composition was mixed and melting-mixed at 50° C. to prepare a resin liquid. The content of methylethylketone (MEK) in the obtained resin liquid was 16.7% by mass. And the viscosity of the resin liquid was 90 mPa·s.

[Composition of the Resin Liquid]

EB 3700 (EBECRYL 3700, a bisphenol-A type epoxy acrylate manufactured by DAICEL-CYTEC Company LTD., viscosity: 2,200 mPa·s at 65° C.)—35.0 parts by mass

BPE200 (NK ESTER BPE-200, ethylene-oxide added bisphenol-A methacrylic acid ester manufactured by Shin-nakamura Chemical Co., Ltd., viscosity: 590 mPa·s at 25° C.)—35.0 parts by mass

BR-31 (NEW FRONTIER BR-31 (solid under room temperatures/melt at 50° C. or higher), a tribromophenoxy ethyl acrylate manufactured by Dai-Ichi Kogyo Seiyaku Co., Ltd.)—30.0 parts by mass

LR 8893X (LUCIRIN LR 8893X, bis(2,6-dimethoxybenzoyl)-2-4-,4-trimethylpentyl phosphine oxide, a radical generator manufactured by BASF Chemical)—2.0 parts by mass

MEK (methylethylketone)—20.5 parts by mass

Next, a support 2 was prepared. Then, using the production apparatus for unit prisms 3 as shown in FIG. 5, a daylighting film 1 was produced.

A translucent PET (polyethylene terephthalate) film which was of 500 mm wide and 100 μm thick was used for the support 2.

A roller which was 700 mm long (in the width direction of the support 2) and 300 mm in diameter made with S45C, a carbon steel, and covered with nickel was used as an embossing roller 83. Grooves with a pitch of 50 μm in the roller-axis direction were formed on the entire circumference of the roller which was about 500 mm long by a cutting process using a diamond cutting tool (having single point).

The cross sectional shape of the grooves is a right-angle triangle with an apex angle of 60°. That is, the grooves were 50 μm in width and about 25 μm in depth. The grooves were endless in the circumferential direction of the embossing roller 83. Using the roller, unit prisms 3 each having a triangle cross sectional shape were formed on a surface of the support 2. The circumferential surface of the roller was plated with nickel after the cutting process for forming the grooves.

A die coater using an extrusion type coating head 82C was used as a drying unit 82.

A resin liquid having the same composition as the daylighting film was used as a coating solution. The supplied amount of the coating solution (resin liquid) to the coating head 82C was controlled using a supply device 82B such that the film thickness of the coating solution (resin liquid) of which the organic solvent had been dried was 20 μm.

A circulating hot air dryer was used as a drying unit 89. The temperature of hot air in the dryer was set at 100° C.

A roller which was 200 mm in diameter covered with a silicone rubber layer with a rubber hardness of 90 degree was used as a nip roller 84. The nip pressure, effective pressure applied to the support from the embossing roller 83 and nip roller 84, was set at 0.5 Pa.

A metal halide lamp was used as a resin hardening unit 85. The resin was irradiated with radiation energy of 1,000 mJ/cm².

And thus a daylighting film which was 90 cm wide and 100 cm long having a pattern such as that shown in FIG. 4 was produced. In each of the unit prisms 3 of the obtained daylighting film 1, the pitch P, or an interval between two unit prisms 3, was 100 μm; the height H was 50 μm measured from on the support 2; the upper elevation angle θ₁, an angle to the support 2, was 45°; the lower elevation angle θ₂, an angle to the support 2, was 90° (the apex angle was 45°); and the width N of a unit prism 3 was 50 μm.

Then, reflecting layers Al having a thickness of 80nm were formed on a surface of each the unit prisms 3 (or on areas of the surface, on which unit prisms 3 are formed, of the support 2) in the above-mentioned reflecting layer forming step.

After the reflecting layer forming step, a protection layer 5 covering the unit prisms 3 and having a flat surface 5a which is substantially parallel to the reference surface of the support 2 was formed on the surface opposite to the surface having the unit prisms of the support 2 in the above-mentioned protection layer forming step. The reference surface of the support 2 is a surface on which unit prisms 3 are not formed and opposite to the surface on which the unit prisms 3 are formed.

Window Equipped with Daylighting Film

The thus obtained daylighting film 1 was placed on the window 11 located in the indoors 10 and then evaluated as to the illuminance thereof. The result is shown in Table 1.

<Evaluation of Illuminance>

In the evaluation, the “near window” was defined as an indoor spot which is at the same height as the windowsill of and about 1 m far from the window 11, and the “far window” was defined as an indoor spot which is at the same height as the windowsill of and about 10m far from the window 11. The daylighting film 1 of the present invention was placed on the window 11, and illuminances (lux) of both the near window and far window were measured. The window 11 was 90 cm wide and 100 cm long. Substantially entire surface of the window 11 was covered with the daylighting film 1 of the present invention.

### Example 2

<Production and Evaluation of Daylighting Film>

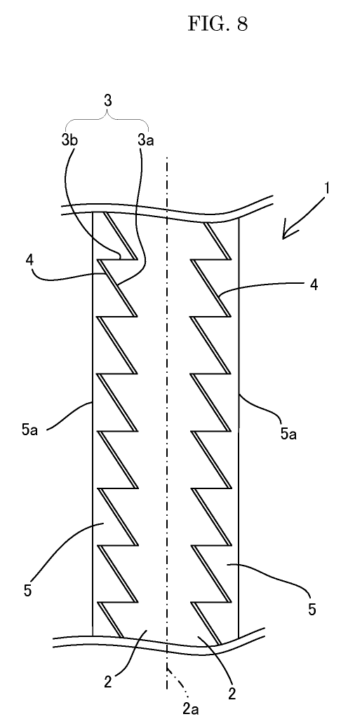

A daylighting film was produced in the same manner as in Example 1 except that, as shown in FIG. 8, two daylighting films of Example 1 were formed in bilayered louvers.

The daylighting film 1 thus obtained was placed on the window 11, and evaluated in the same manner as in Example 1. The result is shown in Table 1.

### Example 3

<Production and Evaluation of Daylighting Film>

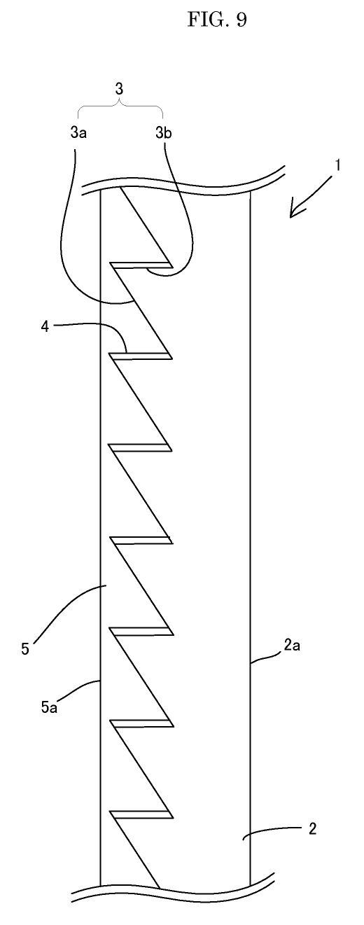

A daylighting film 1 was produced in the same manner as in Example 1 except that, as shown in FIG. 9, reflecting layers 4 were formed on the second surfaces 3b instead of the first surfaces 3a of the unit prisms 3.

The daylighting film 1 thus obtained was placed on the window 11, and evaluated in the same manner as in Example 1. The result is shown in Table 1.

### Example 4

<Production and Evaluation of Daylighting Film>

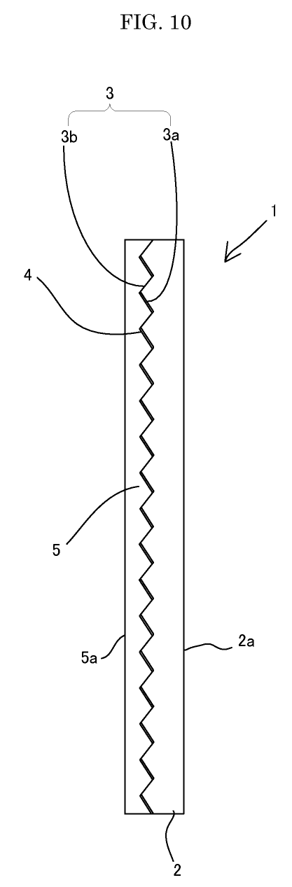

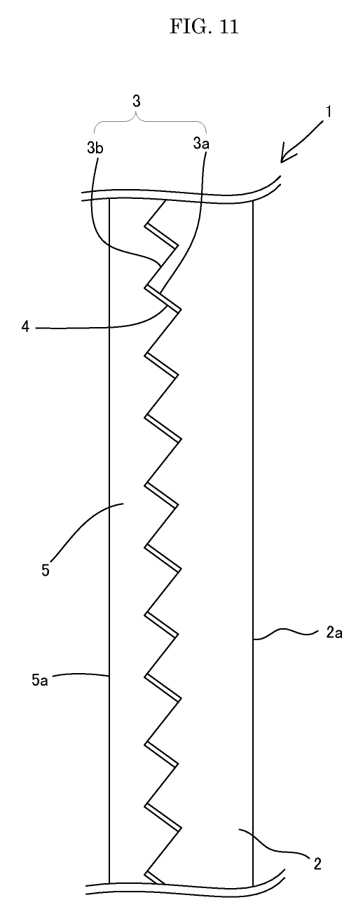

A daylighting film 1 was produced in the same manner as in Example 1 except that, as shown in FIG. 10, the shape of unit prisms was changed so that the angle of the first surfaces 3a of the unit prisms to the flat surface 5a was changed from right angle to not right angle, thus any surface of the unit prisms 3 was not making a right angle with the flat surface 5a and the first surfaces 3a were making an acute angle with the flat surface 5a.

The daylighting film 1 thus obtained was placed on the window 11, and evaluated in the same manner as in Example 1. The result is shown in Table 1.

### Example 5

<Production and Evaluation of Daylighting Film>

A daylighting film 1 was produced in the same manner as in Example 1 except that, as shown in FIG. 11, the shape of unit prisms was changed so that the angle of the first surfaces 3a to the unit prisms and the flat surface 5a was changed from right angle to not right angle, any surface of the unit prisms 3 was not making a right angle with the flat surface 5a, and the first and second surfaces, 3a and 3b, were making a right angle.

The daylighting film 1 thus obtained was placed on the window 11, and evaluated in the same manner as in Example 1. The result is shown in Table 1.

### Comparative Example 1

<Production and Evaluation of Daylighting Film>

A daylighting film 1 was produced in the same manner as in Example 1, except that reflecting layers 4 were not formed in the method for producing a daylighting film.

The daylighting film 1 thus obtained was placed on the window 11, and evaluated in the same manner as in Example 1. The result is shown in Table 1.

### Comparative Example 2

<Production and Evaluation of Daylighting Film>

A daylighting film 1 was produced in the same manner as in Example 1 except that a protection layer 5 was not formed in the method for producing a daylighting film.

The daylighting film 1 thus obtained was placed on the window 11, and evaluated in the same manner as in Example 1. The result is shown in Table 1.

TABLE 1

Illuminance (lx)

| | Near window | Far window |
|---|---|---|
| | spot | spot |
| Ex. 1 | 1,000 | 500 |
| Ex. 2 | 900 | 600 |
| Ex. 3 | 900 | 600 |
| Ex. 4 | 1,100 | 400 |
| Ex. 5 | 1,000 | 400 |
| Comp. Ex. 1 | 4,000 | 200 |
| Comp. Ex. 2 | 1,000 | 500 |

As the results shown in Table 1 show, the window 11 equipped with the daylighting film 1 of Example 1 provided illumination at the far window.

As the results shown in Table 1 show, the window 11 equipped with the daylighting film 1 of Example 2 provided illumination at the far window more.

As the results shown in Table 1 show, the window 11 equipped with the daylighting film 1 of Example 3 provided visibility from the indoors to the outdoors because the reflecting layers 4 did not shut the light path, and it further provided more illumination at the far window.

As the results shown in Table 1 show, the window 11 equipped with the daylighting film 1 of Example 4 provided visibility from the indoors to the outdoors because the reflecting layers 4 did not shut the light path, and it further provided the far window more illumination.

As the results shown in Table 1 show, the window 11 equipped with the daylighting film 1 of Example 5 provided visibility from the indoors to the outdoors because the reflecting layers 4 did not shut the light path, and it further provided more illumination at the far window.

In contrast, the window 11 equipped with the daylighting film 1 of Comparative Example 1 provided an excessive amount of illumination at the near window, while it did not provide illumination at the far window.

The reflecting layer of the window 11 equipped with the daylighting film 1 of Comparative Example 2 was substantially exfoliated after using one month, resulted in a reduction in and unevenness of the light concentration capability, in contrast to the window 11 equipped with the daylighting film 1 of Example 1, which was provided with the protection layer thereon, showed no apparent surface defects.

The daylighting film of the present invention can easily be placed on a window and sufficiently concentrate sunlight into a specific direction. Thus, it can preferably be used for not only windows but also plastic greenhouses, doors, walls, roofs and the like to efficiently take sunlight therefrom into the indoors.

Furthermore, when the daylighting film of the present invention is placed on a glass window, it is placed as a film and can prevent shards of glass from scattering even when the window is crashed, thus the film can function as a security film.

And further, using the daylighting film of the present invention, the indoors can be illuminated with indirect illumination other than strong light from a light source or direct illumination such as sunlight, thus shadow of hands can be prevented from casting around the hands during fine hand manipulation. For this reason, the daylighting film is used as a preferable indirect light source.

What is claimed is:

1. A method for producing a daylighting film, comprising:
forming unit prisms each having two or more surfaces, on at least one surface of a translucent support,
forming one or more reflecting layers on one or more surfaces of each of the unit prisms, and
forming a protection layer having a flat surface to cover the unit prisms.

2. The method for producing a daylighting film according to claim 1, wherein
each of the unit prisms has a ridge line in a direction, and
the unit prisms are arranged such that the respective ridge lines are parallel to each other at predetermined intervals in a direction perpendicular to the direction.

3. The method for producing a daylighting film according to claim 1, including
bonding surfaces of two supports together,
wherein unit prisms are formed on a surface of each support and each surface to be bonded is a surface opposite to the surface with the unit prisms.

4. The method for producing a daylighting film according to claim 1, wherein
at least one surface of each of the unit prisms is perpendicular to the flat surface.

5. The method for producing a daylighting film according to claim 1, wherein
an angle made between a surface and another surface of each of the unit prisms is perpendicular.

6. A daylighting film, wherein
a method for producing a daylighting film comprises:
forming unit prisms each having two or more surfaces, on at least one surface of a translucent support,
forming one or more reflecting layers on one or more surfaces of each of the unit prisms, and
forming a protection layer having a flat surface to cover the unit prisms.

7. The daylighting film according to claim 6, wherein
the unit prisms are formed on at least one surface of the translucent support,
the reflecting layers are formed on the one or more surfaces of each of the unit prisms,
and the protection layer is formed to cover the unit prisms and provide the flat surface.

8. The daylighting film according to claim 6, wherein the reflecting layers are formed in a louver arrangement.

9. A window, comprising:
a daylighting film,
wherein the daylighting film is produced by a method for producing a daylighting film, the method comprises:
forming unit prisms each having two or more surfaces, on at least one surface of a translucent support,
forming one or more reflecting layers on one or more surfaces of each of the unit prisms, and
forming a protection layer having a flat surface to cover the unit prisms.
